(19) United States
(12) Patent Application Publication
(10) Pub. No.: US 2011/0233275 A1
(43) Pub. Date: Sep. 29, 2011

(54) Gas pump bill & change acceptor

(76) Inventor: Ellisa L. Young, New Castle, DE (US)

(21) Appl. No.: 13/065,592

(22) Filed: Mar. 24, 2011

Related U.S. Application Data
(60) Provisional application No. 61/340,973, filed on Mar. 25, 2010.

(51) Int. Cl. G07F 15/00

(52) U.S. Cl. 235/381

(57) ABSTRACT

The present invention provides means for customers who prefer to pay with cash to pay for their gasoline at the pump. The Gas Pump Bill & Change Acceptor is a specially designed electronic moneychanger, incorporated into the design of existing or newly manufactured gasoline pumps. Similar in appearance and function to traditional gasoline pumps, the Gas Pump Bill & Change Acceptor is a two sided pump configured with a single or multiple dispenser tanks, offering consumers various grades of gasoline, and/or diesel fuel, with operational buttons for each appropriately positioned on the unit's control panel. Most notably, incorporated into the design of this panel is an alphanumeric keypad, programmed to accept coins, dollar bills and credit cards, as opposed to merely credit cards alone. An LCD (liquid crystal display) panel is also included and is programmed to display specific directional prompts for customer use.

### CLAIM OF PRIORITY

This patent application claims priority under 35 USC 119 (e) (1) from U.S. Provisional Patent Application Ser. No. 61/340,973 filed Mar. 25, 2010, of common inventorship herewith entitled, “Gas Pump Bill & Change Acceptor.”

### FIELD OF THE INVENTION

The present invention pertains to the field of gasoline dispensing payment devices, and more specifically to the field of bill and coin gasoline dispensing payment devices.

### BACKGROUND OF THE INVENTION

The prior art has put forth several designs for bill and coin gasoline dispensing payment devices. Among these are:

U.S. Pat. No. 3,365,045 to Wolf Guttmann and Kenneth H. Miller describes a self-service system for operating a gasoline pump by depositing money in a system. The system is operative in response to the deposit of money therein by counting the deposited money and actuating the pump to deliver a quantity of gasoline equal to the equivalent of the money deposited by the customer.

U.S. Pat. No. 3,921,854 to Thomas D. Formica describes a control unit and dispensers for a gasoline station providing for prepayment at a single control of fuel dispensing at each of a plurality of dispensers, and automatic payout of change whenever a customer does not take all of the gasoline paid for.

U.S. Pat. No. 4,724,334 to Bernard Melek describes a money operated control used to control and operate a selected one of a plurality of electrical units such as washing, drying or gas-dispensing machines.

None of these prior art references describe the present invention.

### SUMMARY OF THE INVENTION

It is an object of the present invention to provide an improved bill and coin gasoline dispensing payment device.

### BRIEF DESCRIPTION OF THE DRAWINGS

FIG. 1 is an elevational angled perspective view of the device of the present invention.

FIG. 2 is a close-up left angled perspective view of a portion of the device of the present invention.

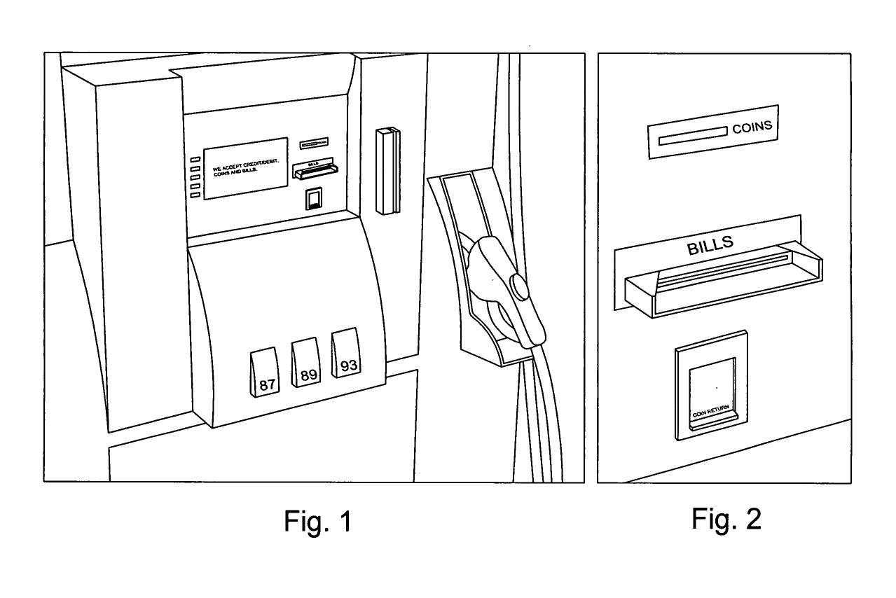

### DETAILED DESCRIPTION OF THE INVENTION

Everyday, millions of people climb into their cars, trucks or minivans and make their way across the highways and byways of this great land. Whether a retired couple embarking on a cross country journey, a college coed enduring a long commute to school, or a busy homemaker driving a few blocks to the neighborhood grocer, automobiles offer consumers a simple way in which to get from one place to another, both safely and easily. People rely on the automobile as the primary means of transportation and the roads and highways are becoming increasingly congested. Travel on major urban roads increased by almost 30 percent from 1997 to 2007. More recently, however, steep increases in gasoline prices have influenced many consumers to cut back on driving, yet fuel is nonetheless a constant demand for most busy motorists.

Catering to today's busy drivers, modern service stations offer commuters a quick and efficient means of fueling their vehicles and getting back on the road in a timely fashion. Long gone are the days when a friendly service attendant happily pumped gas for the customer, checking the oil and cleaning the windshield prior to accepting cash for the service. In fact, the vast majority of service stations are “self serve,” with the customer pumping their own gas and in many cases, paying for their purchases right at the pump, via a credit or debit card. As most service stations have small convenience stores where everything from soda pop, bottled water and beer, to hairspray, diapers and motor oil are sold, the lines in these stations can be somewhat long, thus the “pay at the pump” option allows busy travelers to quickly get back on the road without having to wait long minutes behind a finicky toddler picking out candy or a senior citizen scratching off lottery tickets in order to do so. Unfortunately, for those consumers who do not have access to a credit card or debit card and therefore must pay for their gasoline with cash, skipping these long lines is simply not an option, as cash purchases must be made directly to the station attendant.

The present invention, hereinafter referred as Gas Pump Bill & Change Acceptor is a modification to the design of fuel pumps that enables customers who prefer to pay with cash to pay for their gasoline at the pump. The Gas Pump Bill & Change Acceptor is a specially designed electronic moneychanger, incorporated into the design of existing or newly manufactured gasoline pumps. Similar in appearance and function to traditional gasoline pumps, the Gas Pump Bill & Change Acceptor is a two sided pump configured with a single or multiple dispenser tanks, offering consumers various grades of gasoline, and/or diesel fuel, with operational buttons for each appropriately positioned on the unit's control panel. Most notably, incorporated into the design of this panel is an alphanumeric keypad, programmed to accept coins, dollar bills and credit cards, as opposed to merely credit cards alone. An LCD (liquid crystal display) panel is also included and is programmed to display specific directional prompts for customer use. Consumers who wish to pay for their gasoline with cash first enters the amount of fuel they wish to purchase on the keypad, next choosing the grade of gasoline. After inserting enough cash into the moneychanger to pay for the gas, the pump's trigger operated dispenser nozzle is released, enabling the user to fill their vehicle. Purchases made by use of the Gas Pump Bill & Change Acceptor does not exceed the amount credited to the user. After the user finishes filling their tank and returns the nozzle to the storage bay, any change due is dispensed to the customer via a cash dispenser and change chute, which is positioned to the side of the keypad.

The Gas Pump Bill & Change Acceptor is a unique and exciting service concept that offers consumers a number of significant benefits and advantages. Foremost, the Gas Pump Bill & Change Acceptor enables those consumers who prefer to pay for their purchases with cash as opposed to with a credit or debit card, a simple and expeditious means of paying for gasoline. Enabling these consumers to conveniently pay for their gasoline right at the pump, the Gas Pump Bill & Change Acceptor rewards cash paying customers by enabling them to get on their way in a more timely manner. Eliminating the need to stand in long lines, simply in order to purchase fuel, the Gas Pump Bill & Change Acceptor allows travelers to simply pay for their cash at the pump and go! Further, by offering this service to cash paying customers, incorporating the Gas Pump Bill & Change Acceptor into the design of gasoline pumps enables service station owners and operators to better care for their customers, potentially resulting in happier clientele and repeat business. Simple to use, consumers appreciate the ease at which they deposit cash into the Gas Pump Bill & Change Acceptor moneychanger, with correct change dispensed directly through the machine.

Enabling consumers to pay for gasoline or diesel fuel with cash, right at the pump, the Gas Pump Bill & Change Acceptor is a unique service that proves an invaluable commodity for millions of drivers. Allowing consumers to purchase gasoline in a quick and easy manner, this electronic moneychanger offers consumers a practical convenience when on the road.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved gasoline pump device, the improvement comprising a bill and coin gasoline dispensing payment device, comprising an electronic moneychanger, incorporated into the design of existing or newly manufactured gasoline pumps, comprising an alphanumeric keypad, programmed to accept coins, dollar bills and credit cards.

2. The device of claim 1 further comprising an LCD (liquid crystal display) panel is programmed to display specific directional prompts for customer use.

3. The device of claim 1 further comprising a cash dispenser and change chute, positioned to the side of the keypad.

4. The device of claim 1 further comprising a receipt dispenser.
